(19) United States
(12) Patent Application Publication
(10) Pub. No.: US 2016/0283019 A1
(43) Pub. Date: Sep. 29, 2016

(54) ELECTRONIC DEVICE, TOUCH COMPONENT AND METHOD FOR CONFIGURING THE SAME

(71) Applicant: Lenovo (Beijing) Limited, Beijing (CN)

(72) Inventor: Yan Long Shang, Beijing (CN)

(21) Appl. No.: 14/814,974

(22) Filed: Jul. 31, 2015

(30) Foreign Application Priority Data
Mar. 25, 2015 (CN) 201510134623.2

(51) Int. Cl. G06F 3/041; G06K 9/00; G06F 3/01; G06F 3/044; G06F 3/045

(52) U.S. Cl. CPC G06F 3/0416; G06F 3/0412; G06F 3/044; G06F 3/045; G06F 3/017; G06K 9/00006; G06F 2203/04111; G06F 2203/04112; G06F 2203/04808

(57) ABSTRACT

One embodiment provides an electronic apparatus, comprising: a touch surface, comprising: a first layer, wherein the first layer is a non-conductive layer; and a second layer comprising touch-sensing components; the second layer having a first region and second region, wherein the second region comprises a higher density of touch-sensing components than the first region; a processing unit operatively coupled to the touch surface; and a memory device that stores instructions executable by the processing unit to: detect, at the touch surface, an input; determine, using the processing unit, a region of the second layer of the touch surface within which the input was detected; and provide a response based upon the region of the second layer of the touch surface within which the input was determined to be detected. Other aspects are described and claimed.

### CLAIM FOR PRIORITY

This application claims priority to Chinese Application No. 201510134623.2, filed on Mar. 25, 2015, which is fully incorporated by reference herein.

### FIELD

The subject matter described herein relates to the field of information technologies, and in particular, to an electronic device, a touch component and a method for configuring the same.

### BACKGROUND

In the prior art, an electronic device acquires a touch operation of a user via a touch screen, and subsequently performs a further operation such as response based on the touch operation. With the development of technologies, more and more users also expect that an electronic device can perform finer operation recognition. However, current electronic devices cannot perform recognition of multiple types of fineness.

### BRIEF SUMMARY

In summary, one aspect provides an electronic apparatus, comprising: a touch surface, comprising: a first layer, wherein the first layer is a non-conductive layer; and a second layer comprising touch-sensing components; the second layer having a first region and second region, wherein the second region comprises a higher density of touch-sensing components than the first region; a processing unit operatively coupled to the touch surface; and a memory device that stores instructions executable by the processing unit to: detect, at the touch surface, an input; determine, using the processing unit, a region of the second layer of the touch surface within which the input was; and provide a response based upon the region of the second layer of the touch surface within which the input was determined to be detected.

Another aspect provides a touch device, comprising: a touch surface, comprising: a first layer wherein the first layer is a non-conductive layer; and a second layer comprising touch-sensing components; the second layer having a first region and a second region, wherein the second region comprises a higher density of touch-sensing components than the first region.

A further aspect provides a method of manufacture, comprising providing a non-conductive layer to form a first layer of a touch surface; and coating a silver nanowire ink on the non-conductive layer to form a second layer comprising touch-sensing components.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 is a schematic structural diagram of an electronic device in accordance with an embodiment showing a cross sectional view of multiple layers and a plan view of a single layer;

FIG. 2 is a schematic structural diagram of a second layer of sub-component;

FIG. 3 is a schematic structural diagram of the two regions in a second layer of sub-component in accordance with an embodiment;

FIG. 4 is a schematic structural diagram of an electronic device in accordance with an embodiment showing a cross sectional view of multiple layers and a plan view of a single layer;

FIG. 5 is schematic structural diagram of a drive component and a detection component in accordance with an embodiment;

FIG. 6 is a schematic diagram of a touch detection in accordance with an embodiment;

FIG. 7 is a schematic structural diagram of an electronic device in accordance with an embodiment showing a cross sectional view of multiple layers and a plan view of a single layer;

FIG. 8 is a schematic structural diagram of a touch component in accordance with an embodiment showing a cross sectional view of multiple layers and a plan view of a single layer;

FIG. 9 is a flow chart of a method for configuring a touch component in accordance with an embodiment;

FIG. 10 is a schematic diagram of a usage scenario 1 in accordance with an embodiment;

FIG. 11 is a schematic diagram of a usage scenario 2 in accordance with an embodiment;

FIG. 12 is a schematic diagram of a usage scenario 3 in accordance with an embodiment;

FIG. 13 is a schematic diagram of a usage scenario 4 in accordance with an embodiment; and

FIG. 14 is a schematic diagram showing arrangement of two regions in a second layer of sub-component in accordance with an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

With respect to the electronic device, touch component and method for configuring the same in embodiments, two regions are provided in the second layer of sub-component, and in the two regions, the conductive materials are configured respectively into two structures having different detection resolutions. In this way, two operations with different fineness can be detected with one touch detection component, thereby improving user's experience in operating the electronic device.

### Embodiment 1

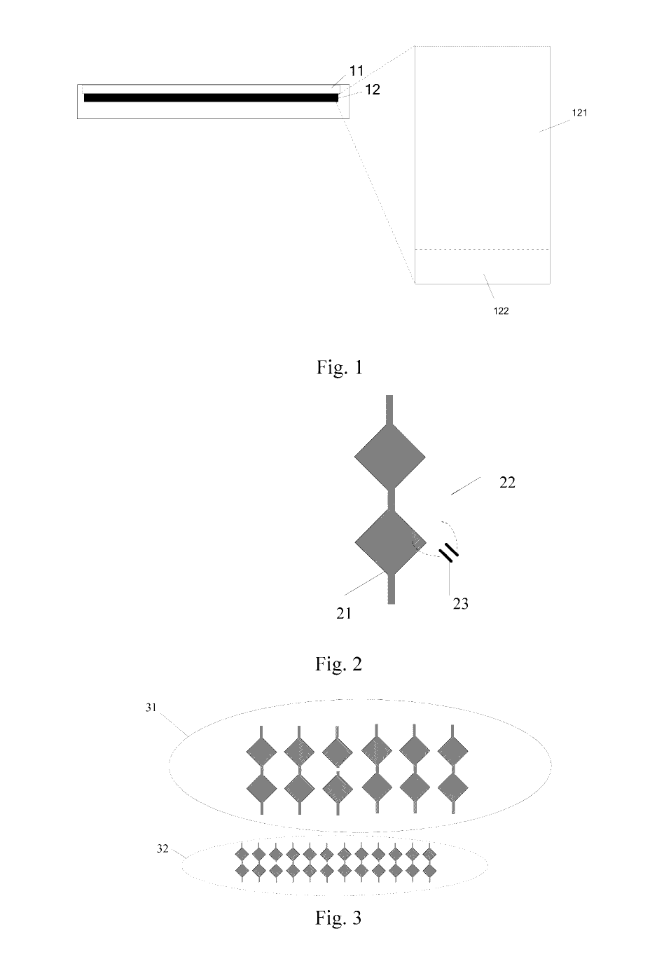

An embodiment provides an electronic device, and the electronic device comprises a touch component as shown in FIG. 1, wherein the touch component is formed by a first layer of sub-component 11 and a second layer of sub-component 12; the first layer of sub-component 11 is made of a non-conductive material, the second layer of sub-component 12 is made of a conductive material; and the second layer of sub-component 12 is overlaid by the first layer of sub-component 11; the second layer of sub-component 12 comprises a first region 121 and a second region 122; and the conductive material of the first region 121 is configured into a structure having a first detection resolution, the conductive material of the second region 122 is configured into a structure having a second detection resolution, wherein the second detection resolution is greater than the first detection resolution.

In an embodiment, the first layer of sub-component is a solid material. For example, when the touch detection component is a resistive touch component, the first layer of sub-component may comprise a hard surface coating and a polyester film; when the touch detection component is a capacitive touch component, the first layer of sub-component may be glass.

Preferably, as shown in FIG. 1, the first region 121 and the second region 122 are arranged not overlapped with each other in the second layer of sub-component 12.

In an embodiment, the structure having the first detection resolution and the structure having the second detection resolution are structures configured in accordance with a type of the touch detection component.

It can be seen from above that in the second layer of sub-component, two regions are provided in which the conductive materials are configured respectively into two structures having different detection resolutions. In this way, two operations with different fineness can be detected with one touch detection component, thereby improving user's experience in operating the electronic device.

### Embodiment 2

An embodiment provides an electronic device, and the electronic device comprises a touch component as shown in FIG. 1, wherein the touch component is formed by a first layer of sub-component 11 and a second layer of sub-component 12; the first layer of sub-component 11 is made of a non-conductive material, the second layer of sub-component 12 is made of a conductive material; and the second layer of sub-component 12 is overlaid by the first layer of sub-component 11; the second layer of sub-component 12 comprises a first region 121 and a second region 122; and the conductive material of the first region 121 is configured into a structure having a first detection resolution, the conductive material of the second region 122 is configured into a structure having a second detection resolution, wherein the second detection resolution is greater than the first detection resolution.

In an embodiment, the first layer of sub-component is a solid material. For example, when the touch detection component is a resistive touch component, the first layer of sub-component may comprise a hard surface coating and a polyester film; when the touch detection component is a capacitive touch component, the first layer of sub-component may be glass.

Preferably, as shown in FIG. 1, the first region 121 and the second region 122 are arranged not overlapped with each other in the second layer of sub-component 12.

The conductive material is a metal material in which the equivalent diameter of component units is accorded with a first threshold so as to support the conductive material to form a structure which detects a touch operation with the second detection resolution. In such a case, the component units may be the minimum component units of the conductive material. The minimum component units may be the minimum components which are observable with a given instrument. The first threshold may be a range of values which is set depending on a practical situation, for example, the first threshold may be set as less than 50 nanometers.

The conductive material of an embodiment may be a silver nanowire (SNW). The SNW is formed by coating an SNW ink on a plastic or glass substrate, and then applying laser etching to obtain a transparent conductive material with a nanoscale silver wire conductive network pattern. Generally, in the prior art, an indium tin oxide (ITO) material is used to manufacture a touch detection component; however, an embodiment uses the SNW to manufacture a touch detection component. Due to the special physical mechanism of forming the SNW, the diameter of the line width of the SNW is extremely small, which is about 50 nm. Therefore, Moire interference would not exist and the SNW can be applied to display screens with various sizes. Additionally, since the line width of an SNW is small, the second layer of sub-component can be guaranteed with a much higher light transmittance.

In an embodiment, the structure having the first detection resolution and the structure having the second detection resolution are structures configured in accordance with the type of the touch detection component.

Preferably, the conductive material in the first region 121 of an embodiment is configured into a structure having the first detection resolution, the conductive material in the second region 122 is configured into a structure having the second detection resolution, and they can be configured simultaneously. They can be configured via laser etching. By one approach, they can be made as follows: first laying an SNW ink on the first layer of sub-component, and then obtaining a first region and a second region on the second layer of sub-component all at once by laser etching based on the desired structures of the first region and the second region. Therefore, two touch regions are configured on the first layer of sub-component via a single process, thereby eliminating additional processes.

It can be seen from above that in the second layer of sub-component, two regions are provided in which the conductive materials are configured respectively into two structures having different detection resolutions. In this way, two operations with different fineness can be detected with one touch detection component, thereby improving user's experience in operating the electronic device and increasing usage scenario.

Furthermore, since the above solution uses a conductive material which is a metal material in which the equivalent diameter of component units is accorded with the first threshold, the second layer of sub-component is configured to have both a structure having the first detection resolution and a structure having the second detection resolution, thereby not only improving the touch detection fineness but also the production efficiency of the electronic device.

### Embodiment 3

An embodiment provides an electronic device, and the electronic device comprises a touch component as shown in FIG. 1, wherein the touch component is formed by a first layer of sub-component 11 and a second layer of sub-component 12; the first layer of sub-component 11 is made of a non-conductive material, the second layer of sub-component 12 is made of a conductive material; and the second layer of sub-component 12 is overlaid by the first layer of sub-component 11; the second layer of sub-component 12 comprises a first region 121 and a second region 122; and the conductive material of the first region 121 is configured into a structure having a first detection resolution, the conductive material of the second region 122 is configured into a structure having a second detection resolution, wherein the second detection resolution is greater than the first detection resolution.

In an embodiment, the first layer of sub-component is a solid material. For example, when the touch detection component is a resistive touch component, the first layer of sub-component may comprise a hard surface coating and a polyester film; when the touch detection component is a capacitive touch component, the first layer of sub-component may be glass.

Preferably, as shown in FIG. 1, the first region 121 and the second region 122 are arranged not overlapped with each other in the second layer of sub-component 12. The second region may be located at one side of the first region, for example, as shown in FIG. 1, at the lower side of the first region. The area of the second region may be smaller than the area of the first region.

The conductive material is a metal material in which the equivalent diameter of component units is accorded with a first threshold so as to support the conductive material to form a structure which detects a touch operation with the second detection resolution. In such a case, the component units may be the minimum component units of the conductive material. The minimum component units may be the minimum components which are observable with a given instrument. The first threshold may be a range of values which is set depending on a practical situation, for example, the first threshold may be set as less than 50 nanometers.

The conductive material of an embodiment may be a silicon nanowire (SNW). The SNW is formed by coating an SNW ink on a plastic or glass substrate, and then applying laser etching to obtain a transparent conductive material with a nanoscale silver wire conductive network pattern. Generally, in the prior art, an indium tin oxide (ITO) material is used to manufacture a touch detection component; however, an embodiment uses the SNW to manufacture a touch detection component. Due to the special physical mechanism of forming SNW, the diameter of the line width of the SNW is extremely small, which is about 50 nm. Therefore, Moire interference would not exist and the SNW can be applied to display screens with various sizes. Additionally, since the line width of the SNW is small, the second layer of sub-component can be guaranteed with a much higher light transmittance.

Preferably, the conductive material in the first region of an embodiment is configured into the structure having the first detection resolution, such that the first region forms a capacitor electrode having the first detection resolution.

Accordingly, the conductive material in the second region is configured into the structure having the second detection resolution, such that the second region forms a capacitor electrode having the second detection resolution. In this case, the structure having the first detection resolution and the structure having the second detection resolution are formed respectively with an array having identical cell patterns; and the cell pattern which corresponds to the structure having the first detection resolution has a size different from that of the cell pattern which corresponds to the structure having the second detection resolution.

The above capacitor electrode can have two types of mutual capacitance, on one side of the first layer of sub-component, a transparent conductive material is used to form an array of transverse electrodes and longitudinal electrodes where the intersections of the two groups of electrodes will form capacitors, i.e., the two groups of electrodes form respectively two poles of the capacitors. For example, as shown in FIG. 2, the electrodes with the lighter color form an array of transverse electrodes, and the electrodes with the darker color form an array of longitudinal electrodes, wherein a transverse electrode 22 and an adjacent longitudinal electrode 21 may form a capacitor electrode 23. It would be appreciated that FIG. 2 illustrates merely capacitor electrodes locally, and in fact, the second layer of sub-component is totally formed by the structure as shown in FIG. 2.

The aforesaid cell pattern is a pattern of any one of the capacitor electrodes of FIG. 2, for example, the transverse electrode 22 or the longitudinal electrode 23. Additionally, as shown in FIG. 3, the size of the cell pattern which corresponds to the structure having the first detection resolution may be illustrated by 31 in the figure, and the size of the cell pattern which corresponds to the structure having the second detection resolution may be illustrated by 32 in the figure, i.e., the size of the cell pattern which corresponds to the structure having the first detection resolution may be N times the size of the cell pattern which corresponds to the structure having the second detection resolution.

Preferably, the conductive material in the first region 121 of an embodiment is configured into the structure having the first detection resolution, the conductive material in the second region 122 is configured into the structure having the second detection resolution, and they can be configured simultaneously. They may be configured via laser etching. By one approach, they can be made as follows: first laying an SNW ink on the first layer of sub-component, and then obtaining a first region and a second region on the second layer of sub-component all at once by laser etching based on the desired structures of the first region and the second region. Therefore, two touch regions are configured on the first layer of sub-component via a single process, thereby eliminating additional processes.

It can be seen from above that in the second layer of sub-component, two regions are provided in which the conductive materials are configured respectively into two structures having different detection resolutions. In this way, two operations with different fineness can be detected with one touch detection component, thereby improving user's experience in operating the electronic device.

Furthermore, since the above solution employs a conductive material which is a metal material the equivalent diameter of the forming unit of which is accorded with the first threshold, the second layer of sub-component is configured simultaneously into a structure having a first detection resolution and a structure having a second detection resolution, thereby improving the touch detection fineness and the production efficiency of the electronic device.

### Embodiment 4

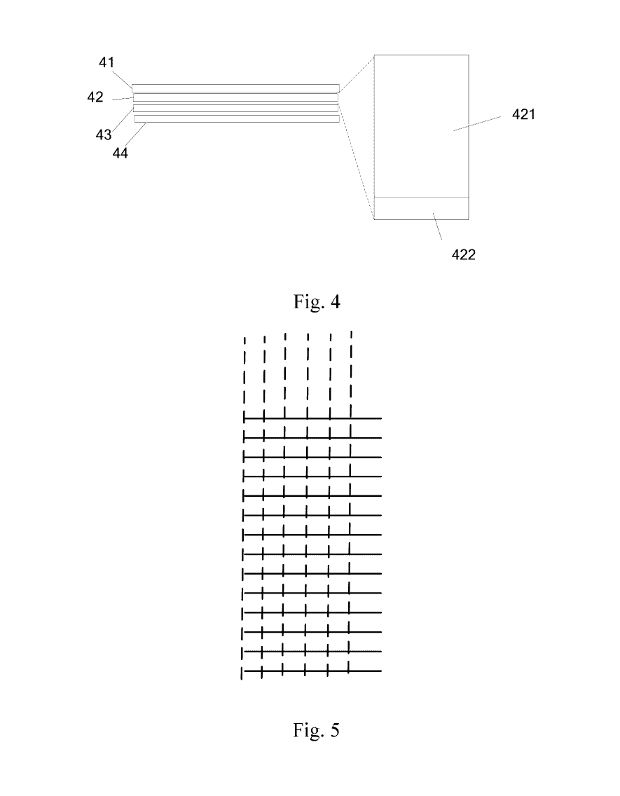

An embodiment provides an electronic device, and the electronic device comprises a touch component as shown in FIG. 4, wherein the touch component is formed by a first layer of sub-component 41 and a second layer of sub-component 42; the first layer of sub-component 41 is made of a non-conductive material, the second layer of sub-component 42 is made of a conductive material; and the second layer of sub-component 42 is overlaid by the first layer of sub-component 41; the second layer of sub-component 42 comprises a first region 421 and a second region 422; and the conductive material of the first region 421 is configured into a structure having a first detection resolution, the conductive material of the second region 422 is configured into a structure having a second detection resolution, wherein the second detection resolution is greater than the first detection resolution.

In an embodiment, the first layer of sub-component is a solid material. For example, when the touch detection component is a resistive touch component, the first layer of sub-component may comprise a hard surface coating and a polyester film; when the touch detection component is a capacitive touch component, the first layer of sub-component may be glass.

Preferably, as shown in FIG. 1, the first region 121 and the second region 122 are arranged not overlapped with each other in the second layer of sub-component.

The conductive material is a metal material in which the equivalent diameter of component units is accorded with a first threshold so as to support the conductive material to form a structure which detects a touch operation with the second detection resolution. In such a case, the component units may be the minimum component units of the conductive material. The minimum component units may be the minimum components which are observable with a given instrument. The first threshold may be a range of values which is set depending on a practical situation, for example, the first threshold may be set as less than 50 nanometers.

The conductive material of an embodiment may be a silicon nanowire (SNW). The SNW is formed by coating an SNW ink on a plastic or glass substrate, and then applying laser etching to obtain a transparent conductive material with a nanoscale silver wire conductive network pattern. Generally, in the prior art, an indium tin oxide (ITO) material is used to manufacture a touch detection component; however, an embodiment uses the SNW to manufacture a touch detection component. Due to the special physical mechanism of forming the SNW, the diameter of the line width of the SNW is extremely small, which is about 50 nm. Therefore, Moire interference would not exist and the SNW can be applied to display screens with various sizes. Additionally, since the line width of an SNW is small, the second layer of sub-component can be guaranteed with a much higher light transmittance.

Preferably, the conductive material in the first region of an embodiment is configured into the structure having the first detection resolution, such that the first region forms a capacitor electrode having the first detection resolution.

Accordingly, the conductive material in the second region is configured into the structure having the second detection resolution, such that the second region forms a capacitor electrode having the second detection resolution. In this case, the structure having the first detection resolution and the structure having the second detection resolution are formed respectively with an array of identical cell patterns; and the cell pattern which corresponds to the structure having the first detection resolution has a size different from that of the cell pattern which corresponds to the structure having the second detection resolution.

The above capacitor electrode can have two types of mutual capacitance, on one side of the first layer of sub-component, a transparent conductive material is used to form an array of transverse electrodes and longitudinal electrodes where the intersections of the two groups of electrodes will form capacitors, i.e., the two groups of electrodes form respectively two poles of the capacitors. For example, as shown in FIG. 2, the electrodes with the lighter color form an array of transverse electrodes, and the electrodes with the darker color form an array of longitudinal electrodes, wherein a transverse electrode 22 and an adjacent longitudinal electrode 21 may form a capacitor electrode 23. It would be appreciated that FIG. 2 illustrates merely capacitor electrodes locally, and in fact, the second layer of sub-component is totally formed by the structure as shown in FIG. 2.

The aforesaid cell pattern is a pattern of any one of the capacitor electrodes of FIG. 2, for example, the transverse electrode 22 or the longitudinal electrode 23. Additionally, as shown in FIG. 3, the size of the cell pattern which corresponds to the structure having the first detection resolution may be illustrated by 31 in the figure, and the size of the cell pattern which corresponds to the structure having the second detection resolution may be illustrated by 32 in the figure, i.e., the size of the cell pattern which corresponds to the structure having the first detection resolution may be N times the size of the cell pattern which corresponds to the structure having the second detection resolution.

Preferably, the conductive material in the first region 121 of an embodiment is configured into the structure having the first detection resolution, the conductive material in the second region 122 is configured into the structure having the second detection resolution, and they can be configured simultaneously. They may be configured via laser etching. By one approach, they can be made as follows: first laying an SNW ink on the first layer of sub-component, and then obtaining a first region and a second region on the second layer of sub-component all at once by laser etching based on the desired structures of the first region and the second region. Therefore, two touch regions are configured on the first layer of sub-component via a single process, thereby eliminating additional processes.

The electronic device may further comprise a drive component 43 and a detection component 44. The drive component 43 is located between the second layer of sub-component 42 and the detection component 44, wherein the drive component 43 is used to supply a driving voltage respectively to the conductive material in the first region and the second region of the second layer of sub-component. The detection component 44 is used to detect the capacitor electrodes in the first region and the second region to obtain at least one capacitance value.

Preferably, the electronic device further comprises a processing unit, used to determine a characteristic parameter of a touch operation based on the at least one capacitance value obtained by the detection component.

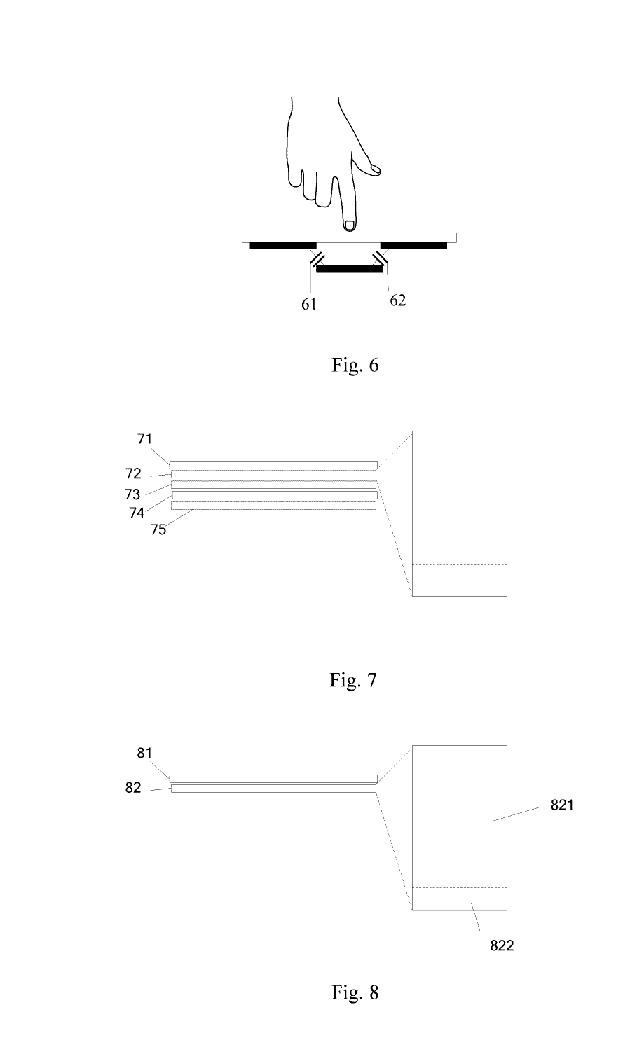

The drive component 43 of an embodiment may be formed by a row of drive wires. The detection component 44 may be formed by a row of detection wires. For example, as shown in FIG. 5, assuming that a plurality of transverse solid lines represents the drive wires in the drive component, then the detection component would be the detection wires formed by a plurality of the vertical dashed lines. For example, as shown in FIG. 6, since coupling between two electrodes in vicinity of a touch spot will be effected due to existence of a finger, when a user touches the first layer of sub-component with a hand, capacitance, which between the two electrodes of mutual capacitances of a capacitor 61 and a capacitor 62 in the first region or the second region of the second layer of sub-component, will change. When detecting the mutual capacitance level, the transverse drive component 43 emits excitation signals successively and the longitudinal detection component receives the signals simultaneously, such that the capacitance values of all of the intersections of the transverse and longitudinal electrodes (i.e., the capacitance of the two-dimensional surface of the whole touch screen) can be obtained. Based on the variation values of the two dimensional capacitance of the touch screen, the coordinates of each touch spot can be obtained via calculation. Therefore, even if a plurality of touch spots is present on the screen, the actual coordinates of each touch spot can also be obtained via calculation.

Preferably, the detection component is specifically used to: when an operating body contacts the first layer of sub-component, detect N capacitance values which correspond to a contact area of the operating body in the first region, or detect M capacitance values which correspond to a contact area of the operating body in the second region, wherein M is an integer greater than N. Accordingly, the processing unit is specifically used to determine a characteristic parameter of the touch operation based on the N capacitance values of the first region obtained by the detection component, and determine a positional parameter which corresponds to the operating body, or, determine a characteristic parameter of the touch operation based on the M capacitance values of the second region, and determine a texture feature value of the operating body.

Here, the operating body may be a finger of the user, and the contact area is the contact or approaching area of the finger with the first layer of sub-component. As shown in FIG. 6, even if the finger is not in contact with the first layer of sub-component, but has an area approaching the first layer of sub-component.

For example, when a finger of the user is in contact with the first layer of sub-component which corresponds to the first region, since the size of the cell pattern in the first region is relatively big, the number of capacitors corresponding to the contact area of the finger is typically small, for example, the number may be 1, i.e., N is 1. After the detection component detects, periodically, each capacitance value, the detected capacitance value will be sent to the processing unit, and the processing unit in turn detects a change of each capacitance value in the current period relative to the capacitance value of the previous period. Upon determining that the variation of a capacitor in the first region is greater than a preset value, the abscissa and the ordinate which correspond to the capacitor will be obtained. As such, the coordinates of the touch spot in the first region is obtained and such coordinates of the touch spot will serve as a characteristic parameter of the touch operation.

When a finger of the user is in contact with the first layer of sub-component which corresponds to the second region, since the size of the cell pattern in the second region is small, the number of capacitors corresponding to the contact area of the finger is typically large, for example, the number is 50. Therefore, when the finger of the user is in contact with the first layer of sub-component, and after the detection component of the second region detects, periodically, each capacitance value, the detected capacitance value will be sent to the processing unit, and the processing unit in turn detects a change of each capacitance value in the current period relative to the capacitance value of the previous period. Upon determining that the variations of multiple capacitors in the second region is greater than preset values, the abscissas and the ordinates which correspond to the multiple capacitors will be obtained. As such, the characteristic parameter of the touch operation in the second region is obtained and in turn, a texture feature value will be determined based on the characteristic parameter. The texture feature value of an embodiment may be the fingerprint of a finger.

Therefore, by merely configuring the touch component in the electronic device, it is ensured that on a complete touch screen of the electronic device, not only detection of a common touch operation, but also a fingerprint identification which requires a very high precision can be achieved, thereby increasing the usage scenario of the touch screen and improving the user experience.

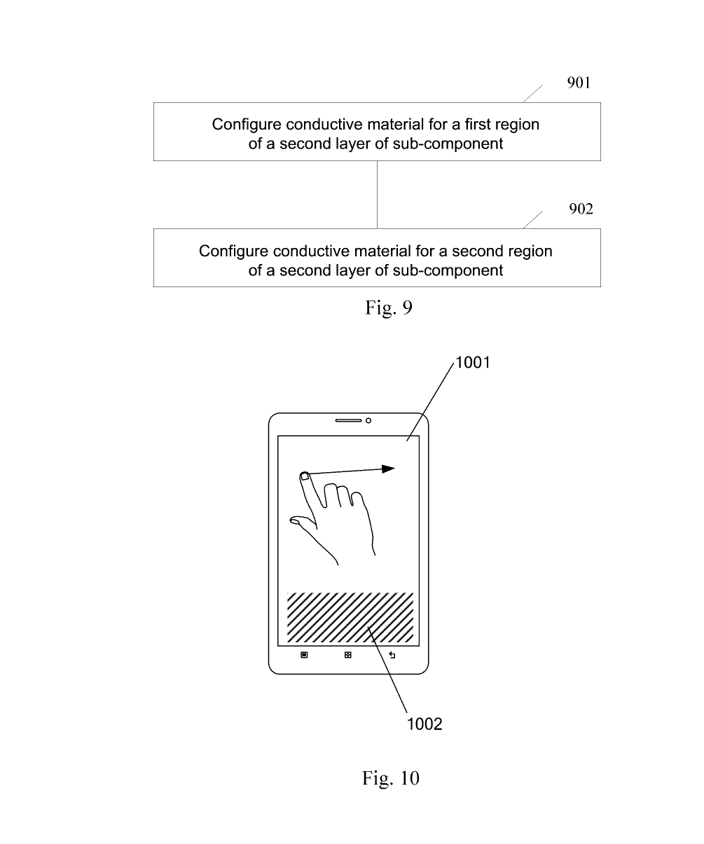

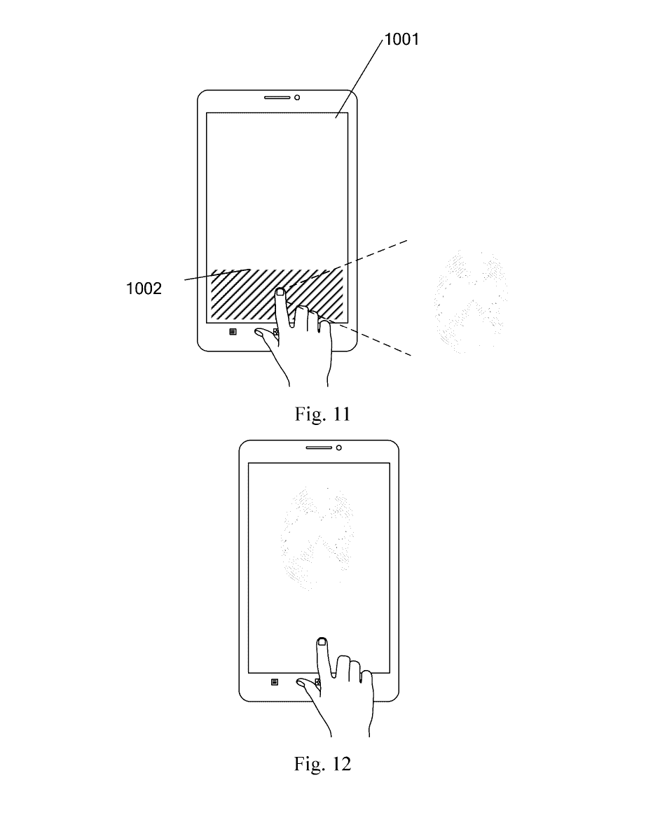

The area of the first region may be larger than the area of the second region, and the first region may be located above the second region. For example, as shown in FIG. 10, the second region 1002 is located at the side close to virtual buttons or physical buttons. Assuming that a user is at a first location 1001, i.e., on the first layer of sub-component corresponding to the first region, and performs a slide operation from the left to the right, as illustrated in the figure, the electronic device will be able to detect an operation gesture of the user. As shown in FIG. 11, assuming that the user enables the fingerprint identification function, or enters the fingerprint identification mode, the system can, in accordance with the pre-set location corresponding to the second region, display by the first layer of sub-component the location where the fingerprint is obtained, i.e., a second location 1002, and then obtain the fingerprint as shown on the right side of FIG. 11 at the second location 1002 which corresponds to the second region. The above description is just a usage scenario, and in practice, more scenarios may be provided. For example, as shown in FIG. 12, the fingerprint may be displayed by the first layer of sub-component at the location of the display component which corresponds to the first region when the fingerprint feature of the user is collected.

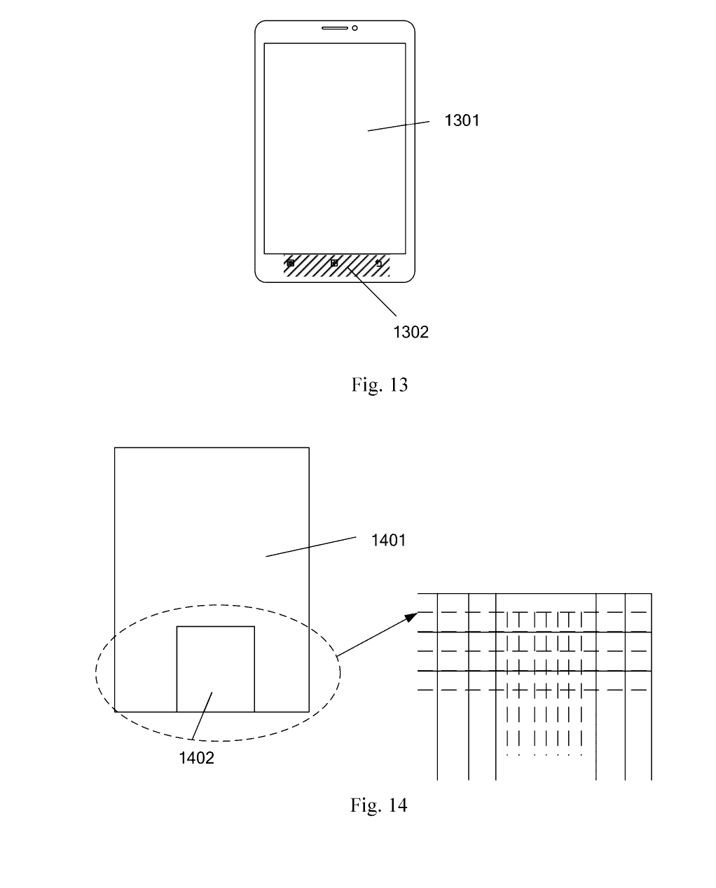

Additionally, the area of the first region may be the same as the area of a display screen of an electronic device in the prior art, for example, a smart phone, and the area of the second region may only be the same as the area of virtual touch buttons of the electronic device. As shown in FIG. 13, the display screen in the figure corresponds to a first region 1301, and the virtual touch control buttons correspond to a second region 1302. As such, by increasing the detection resolution at the locations of the virtual touch buttons, corresponding functions of the virtual touch buttons can be added while still maintaining existing functions of the touch display screen of the electronic device.

It can be seen from above solution that, in the second layer of sub-component, two regions are provided in which the conductive materials are configured respectively into two structures having different detection resolutions. Therefore, two operations with different fineness can be detected with one touch detection component, thereby improving user experience in operating the electronic device. Furthermore, since the above solution uses a conductive material which is a metal material in which the equivalent diameter of component units is accorded with the first threshold, the second layer of sub-component is configured to have both a structure having the first detection resolution and a structure having the second detection resolution, thereby not only improving the touch detection fineness but also the production efficiency of the electronic device.

### Embodiment 5

An embodiment provides an electronic device, and the electronic device comprises a touch component as shown in FIG. 4, wherein the touch component is formed by a first layer of sub-component 41 and a second layer of sub-component 42; the first layer of sub-component 41 is made of a non-conductive material, the second layer of sub-component 42 is made of a conductive material; and the second layer of sub-component 42 is overlaid by the first layer of sub-component 41; the second layer of sub-component 42 comprises a first region 421 and a second region 422; and the conductive material of the first region 421 is configured into a structure having a first detection resolution, the conductive material of the second region 422 is configured into a structure having a second detection resolution, wherein the second detection resolution is greater than the first detection resolution.

In an embodiment, the first layer of sub-component is a solid material. For example, when the touch detection component is a resistive touch component, the first layer of sub-component may comprise a hard surface coating and a polyester film; when the touch detection component is a capacitive touch component, the first layer of sub-component may be glass.

Preferably, as shown in FIG. 1, the first region 121 and the second region 122 are arranged not overlapped with each other in the second layer of sub-component.

The conductive material is a metal material in which the equivalent diameter of component units is accorded with a first threshold so as to support the conductive material to form a structure which detects a touch operation with the second detection resolution. In such a case, the component units may be the minimum component units of the conductive material. The minimum component units may be the minimum components which are observable with a given instrument. The first threshold may be a range of value which is set depending on a practical situation, for example, the first threshold may be set as less than 50 nanometers.

The conductive material of an embodiment may be a silicon nanowire (SNW). The SNW is formed by coating an SNW ink on a plastic or glass substrate, and then applying laser etching to obtain a transparent conductive material with a nanoscale silver wire conductive network pattern. Generally, in the prior art, an indium tin oxide (ITO) material is used to manufacture a touch detection component; however, an embodiment uses the SNW to manufacture a touch detection component. Due to the special physical mechanism of forming SNW, the diameter of the line width of the SNW is extremely small, which is about 50 nm. Therefore, Moire interference would not exist and it can be applied to display screens with various sizes. Additionally, since the line width of an SNW is small, the second layer of sub-component can be guaranteed with a much higher light transmittance.

Preferably, the conductive material in the first region of an embodiment is configured into the structure having the first detection resolution, such that the first region forms a capacitor electrode having the first detection resolution.

Accordingly, the conductive material in the second region is configured into the structure having the second detection resolution, such that the second region forms a capacitor electrode having the second detection resolution. In this case, the structure having the first detection resolution and the structure having the second detection resolution are formed respectively with an array with identical cell patterns; and the cell pattern which corresponds to the structure having the first detection resolution has a size different from that of the cell pattern which corresponds to the structure having the second detection resolution.

The above capacitor electrode can have two types of mutual capacitance, on one side of the first layer of sub-component, a transparent conductive material is used to form an array of transverse electrodes and longitudinal electrodes where the intersections of the two groups of electrodes will form capacitors, i.e., the two groups of electrodes form respectively two poles of the capacitors. For example, as shown in FIG. 2, the electrodes with the lighter color form the array of transverse electrodes, and the electrodes with the darker color form the array of longitudinal electrodes, wherein a transverse electrode 22 and an adjacent longitudinal electrode 21 may form a capacitor electrode 23. It would be appreciated that FIG. 2 illustrates merely capacitor electrodes locally, and in fact, the second layer of sub-component is totally formed by the feature as shown in FIG. 2.

The aforesaid cell pattern is a pattern of any one of the capacitor electrodes of FIG. 2, for example, the transverse electrode 22 or the longitudinal electrode 23. Additionally, as shown in FIG. 3, the size of the cell pattern which corresponds to the structure having the first detection resolution may be illustrated by 31 in the figure, and the size of the cell pattern which corresponds to the structure having the second detection resolution may be illustrated by 32 in the figure, i.e., the size of the cell pattern which corresponds to the structure having the first detection resolution may be N times the size of the cell pattern which corresponds to the structure having the second detection resolution.

The electronic device may further comprise a drive component 43 and a detection component 44. The drive component 43 is located between the second layer of sub-component 42 and the detection component 44, wherein the drive component 43 is used to supply a driving voltage respectively to the conductive material in the first region and the second region of the second layer of sub-component. The detection component 44 is used to detect the capacitor electrodes in the first region and the second region to obtain at least one capacitance value.

Preferably, the electronic device further comprises a processing unit, used to determine a characteristic parameter of a touch operation based on the at least one capacitance value obtained by the detection component.

The drive component 43 of an embodiment may be formed by a row of drive wires. The detection component 44 may be formed by a row of detection wires. For example, as shown in FIG. 5, assuming that a plurality of transverse solid lines represents the drive wires in the drive component, then the detection component would be the detection wires formed by a plurality of vertical dashed lines. For example, as shown in FIG. 6, since coupling between two electrodes in vicinity of a touch spot will be effected due to existence of a finger, when a user touches the first layer of sub-component with a hand, capacitance, which between the two electrodes of mutual capacitances of a capacitor 61 and a capacitor 62 in the first region or the second region of the second layer of sub-component, will change. When detecting the mutual capacitance level, the transverse drive component 43 emits excitation signals successively and the longitudinal detection component receives the signals simultaneously, such that the capacitance values of all of the intersections of the transverse and longitudinal electrodes (i.e., the capacitance of the two-dimensional surface of the whole touch screen) can be obtained. Based on the variation values of the two dimensional capacitance of the touch screen, the coordinates of each touch spot can be obtained via calculation. Therefore, even if a plurality of touch spots is present on the screen, the actual coordinates of each touch spot can also be obtained via calculation.

Preferably, the detection component is specifically used: when an operating body contacts the first layer of sub-component, to detect N capacitance values which correspond to a contact area of the operating body in the first region, or to detect M capacitance values which correspond to a contact area of the operating body in the second region, wherein M is an integer greater than N. Accordingly, the processing unit is specifically used to determine a characteristic parameter of the touch operation based on the N capacitance values of the first region obtained by the detection component, and determine a positional parameter which corresponds to the operating body, or, determine a characteristic parameter of the touch operation based on the M capacitance values of the second region, and determine a texture feature value of the operating body.

Here, the operating body may be a finger of the user, and the contact area is the contact or approaching area of the finger with the first layer of sub-component. As shown in FIG. 6, even if the finger is not in contact with the first layer of sub-component, but has an area approaching the first layer of sub-component.

For example, when a finger of the user is in contact with the first layer of sub-component which corresponds to the first region, since the size of the cell pattern in the first region is relatively big, the number of capacitors corresponding to the contact area of the finger is typically small, for example, the number may be 1, i.e., N is 1. After the detection component detects, periodically, each capacitance value, the detected capacitance value will be sent to the processing unit, and the processing unit in turn detects a change of each capacitance value in the current period relative to the capacitance value of the previous period. Upon determining that the variation of a capacitor in the first region is greater than a preset value, the abscissa and the ordinate which correspond to the capacitor will be obtained. As such, the coordinates of the touch spot in the first region is obtained and such coordinates of the touch spot will serve as a characteristic parameter of the touch operation.

When a finger of the user is in contact with the first layer of sub-component which corresponds to the second region, since the size of the cell pattern in the second region is small, the number of capacitors corresponding to the contact area of the finger is typically large, for example, the number is 50. Therefore, when the finger of the user is in contact with the first layer of sub-component, and after the detection component of the second region detects, periodically, each capacitance value, the detected capacitance value will be sent to the processing unit, and the processing unit in turn detects a change of each capacitance value in the current period relative to the capacitance value of the previous period. Upon determining that the variations of multiple capacitors in the second region is greater than preset values, the abscissas and the ordinates which correspond to the multiple capacitors will be obtained. As such, the characteristic parameter of the touch operation in the second region is obtained and in turn, a texture feature value will be determined based on the characteristic parameter. The texture feature value of an embodiment may be the fingerprint of a finger.

In an embodiment, the first layer of sub-component has a transmittance exceeding a second threshold in a predetermined direction, wherein the predetermined direction is a direction from the second layer of sub-component to the first layer of sub-component. The first layer of sub-component may be a transparent solid material, for example, a glass.

Preferably, as shown in FIG. 7, the electronic device provided in an embodiment further comprises a display component 75, wherein the display component 75 is used to output information by adjusting light ray which is able to go through the first layer of sub-component 71 such that the processing unit can obtain, via the second layer of sub-component 72, the characteristic parameter of the touch operation performed by an operating body on the first layer of sub-component 71 corresponding to the information.

Therefore, by merely configuring the touch component in the electronic device, it is ensured that on a complete touch screen of the electronic device, not only detection of a common touch operation, but also a fingerprint identification which requires a very high precision can be achieved, thereby increasing the usage scenario of the touch screen and improving the user experience.

Additionally, the electronic device provided in FIG. 7 further comprises a drive component 73 and a detection component 74, they function the same as those described above, and thus will not be repeated here.

The display component is positioned on the first layer of sub-component and disposed respectively on the opposite side of the second layer of sub-component. The display component in an embodiment may comprise liquid crystals whose arrangement orientation can be adjusted so as to adjust the light transmittance to display output information via the display component.

Therefore, by merely configuring the touch component in the electronic device, it is ensured that on a complete touch screen of the electronic device, not only detection of a common touch operation, but also a fingerprint identification which requires a very high precision can be achieved, thereby increasing the usage scenario of the touch screen and improving the user experience. The area of the first region may be larger than the area of the second region, and the first region may be located above the second region. For example, as shown in FIG. 10, the second region 1002 is located at the side close to virtual buttons or physical buttons. Assuming that a user is at a first location 1001, i.e., on the first layer of sub-component corresponding to the first region, and performs a slide operation from the left to the right, as illustrated in the figure, the electronic device will be able to detect an operation gesture of the user. As shown in FIG. 11, assuming that the user enables the fingerprint identification function, or enters the fingerprint identification mode, the system can, in accordance with the pre-set location corresponding to the second region, display by the first layer of sub-component the location where the fingerprint is obtained, i.e., a second location 1002, and then obtain the fingerprint as shown on the right side of FIG. 11 at the second location 1002 which corresponds to the second region.

The above description is just a usage scenario, and in practice, more scenarios may be provided. For example, as shown in FIG. 12, the fingerprint may be displayed by the first layer of sub-component at the location of the display component which corresponds to the first region when the fingerprint feature of the user is collected.

The scenarios depicted in FIG. 10 to FIG. 12 may be applied to electronic devices having physical buttons. The physical buttons of such an electronic device follow a process different from that of a touch display screen. Additionally, the scenarios depicted by the three figures are scenarios where the second region is located at one side of the first region.

In practice, the first region and the second region may be of the arrangement illustrated in FIG. 14, i.e., the second region 1402 may also be disposed in the first region 1401, but such an arrangement will cause the arrangement of the detection component and the drive component being relatively different from the scenarios in the FIG. 10 to FIG. 12. For example, as shown on the right side of FIG. 14, the first region contains the second region, which would require more drive wires and detection wires to be configured to ensure proper detection of a touch operation. In FIG. 14, the arrangements of the drive wires and the detection wires corresponding to the first region are represented by solid lines, while the arrangements of the drive wires and the detection wires corresponding to the second region are represented by dashed lines, so as to ensure a correct detection of a touch operation.

Additionally, the area of the first region may be the same as the area of a display screen of an electronic device in the prior art, for example, a smart phone, and the area of the second region may only be the same as the area of virtual touch buttons of the electronic device. As shown in FIG. 13, the display screen in the figure corresponds to a first region 1301, and the virtual touch control buttons correspond to a second region 1302. As such, by increasing the detection resolution at the locations of the virtual touch buttons, corresponding functions of the virtual touch buttons can be added while still maintaining existing functions of the touch display screen of the electronic device.

It can be seen from the above solution that, in the second layer of sub-component, two regions are provided in which the conductive materials are configured respectively into two structures having different detection resolutions. Therefore, two operations with different fineness can be detected with one touch detection component, thereby improving user's experience in operating the electronic device. Furthermore, since the above solution uses a conductive material which is a metal material in which the equivalent diameter of component units is accorded with the first threshold, the second layer of sub-component is configured to have both a structure having the first detection resolution and a structure having the second detection resolution, thereby improving the touch detection fineness and production efficiency of the electronic device.

### Embodiment 6

An embodiment provides a touch component as shown in FIG. 8, wherein the touch component is formed by a first layer of sub-component 81 and a second layer of sub-component 82; the first layer of sub-component 81 is made of a non-conductive material, the second layer of sub-component 82 is made of a conductive material; and the second layer of sub-component 82 is overlaid by the first layer of sub-component 81; the second layer of sub-component 82 comprises a first region 821 and a second region 822; and the conductive material of the first region 821 is configured into a structure having a first detection resolution, the conductive material of the second region 822 is configured into a structure having a second detection resolution, wherein the second detection resolution is greater than the first detection resolution.

In an embodiment, the first layer of sub-component is a solid material. For example, when the touch detection component is a resistive touch component, the first layer of sub-component may comprise a hard surface coating and a polyester film; when the touch detection component is a capacitive touch component, the first layer of sub-component may be glass.

Preferably, the first region 821 and the second region 822 are arranged not overlapped with each other in the second layer of sub-component. It can be understood that, only one arrangement of the first region and the second region is illustrated, and in practice, the first region and the second region may be that the second region is located at one side of the first region, or the second region is located within the first region.

In an embodiment, the structure having the first detection resolution and the structure having the second detection resolution are structures configured in accordance with the type of the touch detection component.

It can be seen from above that in the second layer of sub-component, two regions are provided in which the conductive materials are configured respectively into two structures having different detection resolutions. Therefore, two operations with different fineness can be detected with one touch detection component, thereby improving user's experience in operating the electronic device.

### Embodiment 7

An embodiment provides a method for configuring a touch component that is applied to an electronic device, as shown in FIG. 9, the method comprises:

Step 901: configuring a conductive material for a first region of a second layer of sub-component of the touch component into a structure having a first detection resolution;

Step 902: configuring a conductive material for a second region of the second layer of sub-component of the touch component into a structure having a second detection resolution, such that the electronic device performs touch detections with different detection resolutions in the first region and the second region, wherein the second detection resolution is greater than the first detection resolution.

In an embodiment, step 901 and step 902 are performed simultaneously.

In an embodiment, the structure of the electronic device, in particular, may be as that shown in FIG. 1. The touch component is formed by a first layer of sub-component and a second layer of sub-component; the first layer of sub-component is made of a non-conductive material, the second layer of sub-component is made of a conductive material; the second layer of sub-component is overlaid by the first layer of sub-component; the second layer of sub-component comprises a first region and a second region; and the conductive material of the first region is configured into a structure having a first detection resolution, the conductive material of the second region is configured into a structure having a second detection resolution, wherein the second detection resolution is greater than the first detection resolution.

The electronic device may be a smart phone, a tablet computer, or the like.

Preferably, the configuring the conductive material for the first region of the second layer of sub-component of the touch component into the structure having the first detection resolution and configuring the conductive material for the second region of the second layer of sub-component of the touch component into the structure having the second detection resolution may comprise: laser etching the conductive material for the first region of the second layer of sub-component of the touch component into the structure having the first detection resolution, and laser etching the conductive material for the second region of the second layer of sub-component of the touch component into the structure having the second detection resolution.

The conductive material is a metal material in which the equivalent diameter of component units is accorded with a first threshold, so as to support the conductive material to form a structure which detects a touch operation with the second detection resolution. In such a case, the component units may be the minimum component units of the conductive material. The minimum component units may be the minimum components which are observable with a given instrument. The first threshold may be a range of values which is set depending on a practical situation, for example, the first threshold may be set as less than 50 nanometers.

The conductive material of an embodiment may be a silicone nanowire (SNW). The SNW is formed by coating an SNW ink on a plastic or glass substrate, and then applying laser etching to obtain a transparent conductive material with a nanoscale silver wire conductive network pattern. Generally, in the prior art, an indium tin oxide (ITO) material is used to manufacture a touch detection component; however, an embodiment uses the SNW to manufacture a touch detection component. Due to the special physical mechanism of forming the SNW, the diameter of the line width of the SNW is extremely small, which is about 50 nm. Therefore, Moire interference would not exist and the SNW can be employed in display screens with various sizes. Additionally, since the line width of an SNW is small, the second layer of sub-component can be guaranteed with a much higher light transmittance.

Preferably, the conductive material in the first region 121 of an embodiment is configured into a structure having the first detection resolution, the conductive material in the second region 122 is configured into a structure having the second detection resolution, and they can be configured simultaneously. They can be configured via laser etching. By one approach, they can be made as follows: first laying an SNW ink on the first layer of sub-component, and then obtaining a first region and a second region on the second layer of sub-component all at once by laser etching based on the desired structures of the first region and the second region. Therefore, two touch regions are configured on the first layer of sub-component via a single process, thereby eliminating additional processes.

Preferably, the conductive material in the first region of an embodiment is configured into the structure having the first detection resolution, such that the first region forms a capacitor electrode having the first detection resolution.

Accordingly, the conductive material in the second region is configured into the structure having the second detection resolution, such that the second region forms a capacitor electrode having the second detection resolution. In this case, the structure having the first detection resolution and the structure having the second detection resolution are formed with an array with identical cell patterns; and the cell pattern which corresponds to the structure having the first detection resolution has a size different from that of the cell pattern which corresponds to the structure having the second detection resolution.

The above capacitor electrode can have two types of mutual capacitance, on one side of the first layer of sub-component, a transparent conductive material is used to form an array of transverse electrodes and longitudinal electrodes where the intersections of the two groups of electrodes will form capacitors, i.e., the two groups of electrodes form respectively two poles of the capacitors. For example, as shown in FIG. 2, the electrodes with the lighter color form the array of transverse electrodes, and the electrodes with the darker color form the array of longitudinal electrodes, wherein a transverse electrode 22 and an adjacent longitudinal electrode 21 may form a capacitor electrode 23. It would be appreciated that FIG. 2 illustrates merely capacitor electrodes locally, and in fact, the second layer of sub-component is totally formed by the feature as shown in FIG. 2.

The aforesaid cell pattern is a pattern of any one of the capacitor electrodes of FIG. 2, for example, the transverse electrode 22 or the longitudinal electrode 23. Additionally, as shown in FIG. 3, the size of the cell pattern which corresponds to the structure having the first detection resolution may be illustrated by 31 in the figure, and the size of the cell pattern which corresponds to the structure having the second detection resolution may be illustrated by 32 in the figure, i.e., the size of the cell pattern which corresponds to the structure having the first detection resolution may be N times the size of the cell pattern which corresponds to the structure having the second detection resolution.

The electronic device may further comprise a drive component 43 and a detection component 44. The drive component 43 is located between the second layer of sub-component 42 and the detection component 44, wherein the drive component 43 is used to supply a driving voltage respectively to the conductive material in the first region and the second region of the second layer of sub-component. The detection component 44 is used to detect the capacitor electrodes in the first region and the second region to obtain at least one capacitance value.

Preferably, the electronic device further comprises a processing unit, used to determine a characteristic parameter of a touch operation based on the at least one capacitance value obtained by the detection component.

The drive component 43 of an embodiment may be formed by a row of drive wires. The detection component 44 may be formed by a row of detection wires. For example, as shown in FIG. 5, assuming that a plurality of transverse solid lines represents the drive wires in the drive component, then the detection component would be the detection wires formed by the plurality of vertical dashed lines. For example, as shown in FIG. 6, since coupling between two electrodes in vicinity of the touch spot will be effected due to existence of a finger, when a user touches the first layer of sub-component with a hand, capacitance, which between the two electrodes of mutual capacitances of a capacitor 61 and a capacitor 62 in the first region or the second region of the second layer of sub-component, will change. When detecting the mutual capacitance level, the transverse drive component 43 emits excitation signals successively and the longitudinal detection component receives the signals simultaneously, such that the capacitance values of all of the intersections of the transverse and longitudinal electrodes (i.e., the capacitance of the two-dimensional surface of the whole touch screen) can be obtained. Based on the variation values of the two dimensional capacitance of the touch screen, the coordinates of each touch spot can be obtained by via calculation. Therefore, even if a plurality of touch spots is present on the screen, the actual coordinates of each touch spot can also be obtained via calculation.

Preferably, the detection component is specifically used to: when an operating body contacts the first layer of sub-component, detect N capacitance values which correspond to a contact area of the operating body in the first region, or detect M capacitance values which correspond to a contact area of the operating body in the second region, wherein M is an integer greater than N. Accordingly, the processing unit is specifically used to determine a characteristic parameter of the touch operation based on the N capacitance values of the first region obtained by the detection component, and determine a positional parameter which corresponds to the operating body, or, determine a characteristic parameter of the touch operation based on the M capacitance values of the second region, and determine a texture feature value of the operating body.

Here, the operating body may be a finger of the user, and the contact area is the contact or approaching area of the finger with the first layer of sub-component. As shown in FIG. 6, even if the finger is not in contact with the first layer of sub-component, but has an area approaching the first layer of sub-component.

For example, when a finger of the user is in contact with the first layer of sub-component which corresponds to the first region, since the size of the cell pattern in the first region is relatively big, the number of capacitors corresponding to the contact area of the finger is typically small, for example, the number may be 1, i.e., N is 1. After the detection component detects, periodically, each capacitance value, the detected capacitance value will be sent to the processing unit, and the processing unit in turn detects a change of each capacitance value in the current period relative to the capacitance value of the previous period. Upon determining that the variation of a capacitor in the first region is greater than a preset value, the abscissa and the ordinate which correspond to the capacitor will be obtained. As such, the coordinates of the touch spot in the first region is obtained and such coordinates of the touch spot will serve as a characteristic parameter of the touch operation.

When a finger of the user is in contact with the first layer of sub-component which corresponds to the second region, since the size of the cell pattern in the second region is small, the number of capacitors corresponding to the contact area of the finger is typically large, for example, the number is 50. Therefore, when the finger of the user is in contact with the first layer of sub-component, and after the detection component of the second region detects, periodically, each capacitance value, the detected capacitance value will be sent to the processing unit, and the processing unit in turn detects a change of each capacitance value in the current period relative to the capacitance value of the previous period. Upon determining that the variations of multiple capacitors in the second region is greater than preset values, the abscissas and the ordinates which correspond to the multiple capacitors will be obtained. As such, the characteristic parameter of the touch in the second region is obtained and in turn, a texture feature value will be determined based on the characteristic parameter. The texture feature value of an embodiment may be the fingerprint of a finger.

Therefore, by merely configuring the touch component in the electronic device, it is ensured that on a complete touch screen of the electronic device, not only detection of a common touch operation, but also a fingerprint identification which requires a very high precision can be achieved, thereby increasing the usage scenario of the touch screen and improving the user experience.

The area of the first region may be larger than the area of the second region, and the first region may be located above the second region. For example, as shown in FIG. 10, the second region 1002 is located at the side close to virtual buttons or physical buttons. Assuming that a user is at a first location 1001, i.e., on the first layer of sub-component corresponding to the first region, and performs a slide operation from the left to the right, as illustrated in the figure, the electronic device will be able to detect an operation gesture of the user. As shown in FIG. 11, assuming that the user enables the fingerprint identification function, or enters the fingerprint identification mode, the system can, in accordance with the pre-set location corresponding to the second region, display by the first layer of sub-component the location where the fingerprint is obtained, i.e., a second location 1002, and then obtain the fingerprint as shown on the right side of FIG. 11 at the second location 1002 which corresponds to the second region.

The above description is just a usage scenario, and in practice, more scenarios may be provided. For example, as shown in FIG. 12, the fingerprint may be displayed by the first layer of sub-component at the location of the display component which corresponds to the first region when the fingerprint feature of the user is collected.

The scenarios depicted in FIG. 10 to FIG. 12 may be applied to electronic devices having physical buttons. The physical buttons of such an electronic device follow a process different from that of a touch display screen. Additionally, the scenarios depicted by the three figures are scenarios where the second region is located at one side of the first region.

In practice, the first region and the second region may be of the arrangement illustrated in FIG. 14, i.e., the second region 1402 may also be disposed in the first region 1401, but such an arrangement will cause the arrangement of the detection component and the drive component being relatively different from the scenarios in the FIG. 10 to FIG. 12. For example, as shown on the right side of FIG. 14, the first region contains the second region, which would require more drive wires and detection wires to be configured to ensure proper detection of a touch operation. In FIG. 14, the arrangements of the drive wires and the detection wires corresponding to the first region are represented by solid lines, while the arrangements of the drive wires and the detection wires corresponding to the second region are represented by dashed lines, so as to ensure a correct detection of a touch operation.

Additionally, the area of the first region may be the same as the area of a display screen of an electronic device in the prior art, for example, a smart phone, and the area of the second region may only be the same as the area of virtual touch buttons of the electronic device. As shown in FIG. 13, the display screen in the figure corresponds to a first region 1301, and the virtual touch control buttons correspond to a second region 1302. As such, by increasing the detection resolution at the locations of the virtual touch buttons, corresponding functions of the virtual touch buttons can be added while still maintaining existing functions of the touch display screen of the electronic device.

It can be seen from above that in the second layer of sub-component, two regions are provided in which the conductive materials are configured respectively into two structures having different detection resolutions. Therefore, two operations with different fineness can be detected with one touch detection component, thereby improving user's experience when operating the electronic device. Furthermore, since the above solution uses a conductive material which is a metal material in which the equivalent diameter of component units is accorded with the first threshold, the second layer of sub-component is configured to have both a structure having the first detection resolution and a structure having the second detection resolution, thereby improving the touch detection fineness and production efficiency of the electronic device.

It would be appreciated that the devices and methods disclosed in embodiments may be implemented by other approaches. Embodiments with respect to the devices as described herein above are merely illustrative, for example, the dividing of the units is just a logic function-based division, and in practice it may have other ways of dividing, for example, multiple units or components may be combined, or integrated into another system, or some features may be omitted, or not performed. Furthermore, the coupling, or direct coupling or communication connection of the various depicted or discussed components may be indirect coupling or communication connection via interfaces, devices or units, and can be in electrical form, mechanical form or in other forms.

The units described above as separated components may be, or may not be physically separated, and the components depicted as units may be, or may not be physical units; they may be positioned at one place, or may be distributed on a plurality of network elements, and, depending on the actual needs, part or all of the units may be selected to implement the objectives of embodiments.

Furthermore, in various embodiments, individual functional units may be integrated into one processing module, or each act separately as a single unit; or two or more units may be integrated into one unit. The integrated unit may be implemented in a hardware form, or implemented in the form of a functional unit implemented by hardware and software.

A person of ordinary skill in the art would understand that part or all of the steps implementing the method embodiments as described above may be implemented with a program instructing related hardware, and the program may be stored in a computer readable storage medium, and upon execution, performing the steps of the method embodiments. The storage medium comprises: a portable storage device, a read-only memory (ROM), a random access memory (RAM), a magnetic disk, an optical disc, or various mediums that may be used to store program codes.

In the context of this document, a storage medium is not a signal and “non-transitory” includes all media except signal media.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An electronic apparatus, comprising:
a touch surface, comprising:
a first layer, wherein the first layer is a non-conductive layer; and
a second layer comprising touch-sensing components;
the second layer having a first region and second region, wherein the second region comprises a higher density of touch-sensing components than the first region;
a processing unit operatively coupled to the touch surface; and
a memory device that stores instructions executable by the processing unit to:
detect, at the touch surface, an input;
determine, using the processing unit, a region of the second layer of the touch surface within which the input was detected; and
provide a response based upon the region of the second layer of the touch surface within which the input was determined to be detected.

2. The electronic apparatus of claim 1, wherein the touch-sensing components of the first region are larger in size than the touch-sensing components of the second region.

3. The electronic apparatus of claim 1, wherein the touch-sensing components comprise capacitor electrodes.

4. The electronic apparatus of claim 1, further comprising a detection component, wherein the detection component operatively detects the input.

5. The electronic apparatus of claim 1, further comprising a drive component, wherein the drive component operatively supplies a driving voltage to the touch-sensing components.

6. The electronic apparatus of claim 1, wherein the first layer allows light transmittance.

7. The electronic apparatus of claim 1, further comprising a display unit, wherein the display unit operatively outputs information through the first layer of the touch surface.

8. The electronic apparatus of claim 1, wherein the second layer is an integral layer.

9. The electronic apparatus of claim 1, wherein the input is determined to be detected within the second region of the second layer of the touch surface and wherein the response comprises fingerprint identification.

10. The electronic apparatus of claim 1, wherein the input is determined to be detected within the first region of the second layer of the touch surface and wherein the response comprises accepting an operation gesture.

11. A touch device, comprising:
a touch surface, comprising:
a first layer wherein the first layer is a non-conductive layer; and
a second layer comprising touch-sensing components;
the second layer having a first region and a second region, wherein the second region comprises a higher density of touch-sensing components than the first region.

12. The touch device of claim 11, wherein the touch-sensing components of the first region are larger in size than the touch-sensing components of the second region.

13. The touch device of claim 11, wherein the touch-sensing components comprise capacitor electrodes.

14. The touch device of claim 11, further comprising detection component, wherein the detection component operatively detects the input.

15. The touch device of claim 11, further comprising a drive component, wherein the drive component operatively supplies a driving voltage to the touch-sensing components.

16. The touch device of claim 11, wherein the first layer allows light transmittance.

17. The touch device of claim 11, further comprising a display unit, wherein the display unit operatively outputs information through the first layer of the touch surface.

18. The touch device of claim 11, wherein the second layer is an integral layer.

19. A method of manufacture, the method comprising:
providing a non-conductive layer to form a first layer of a touch surface; and
coating a silver nanowire ink on the non-conductive layer to form a second layer comprising touch-sensing components;
the second layer having a first region and a second region, wherein the second region comprises a higher density of touch-sensing components than the first region.

20. The method according to claim 19, wherein the coating the silver nanowire ink on the non-conductive layer to form the second layer involves laser etching.
